(19) United States
(12) Patent Application Publication
(10) Pub. No.: US 2010/0150743 A1
(43) Pub. Date: Jun. 17, 2010

(54) Single Line Venturi Apparatus

(75) Inventor: Kenneth P. Dellach, Shelby Township, MI (US)

Correspondence Address: YOUNG BASILE, 3001 WEST BIG BEAVER ROAD, SUITE 624, TROY, MI, 48084, US

(73) Assignee: Norgren Automotive, Inc., Clinton Township, MI (US)

(21) Appl. No.: 12/544,439

(22) Filed: Aug. 20, 2009

Related U.S. Application Data
(60) Provisional application No. 61/121,962, filed on Dec. 12, 2008.

(51) Int. Cl. F04F 5/48; B66C 1/02

(52) U.S. Cl. 417/182

(57) ABSTRACT

An apparatus for providing vacuum to a material handling device. The apparatus of the present invention provides a housing having an aperture extending therethrough. The aperture has an inlet end for receiving a supply of pressurized air and an outlet end. A valve is slidably disposed within said aperture of said housing for movement between a vacuum position, wherein vacuum is provided to the material handling device through the use of a venturi, and a release position, wherein atmosphere air pressure is provided directly to said material handling device.

The present application is a formalization of U.S. Provisional Patent Application Ser. No. 61/121,962, filed on Dec. 12, 2008.

### FIELD OF THE INVENTION

The present invention generally relates to vacuum cup assemblies employed for engaging and transporting workpieces, and in particular, an industrial vacuum cup assembly that provides a single line venturi for increasing the efficiency in which to engage and release the workpiece from the vacuum cup assembly.

### BACKGROUND OF THE INVENTION

Various material handling devices are widely used in industry to transport and handle various workpieces. One such common material handling device is a vacuum cup assembly which utilizes vacuum to secure and transport various workpieces having substantially flat surfaces, such as sheet metal and glass. These vacuum cup assemblies typically provide a vacuum cup connected to a vacuum cup mount that provides or generates vacuum to the vacuum cup. One such known design provides a supply of vacuum directly to the vacuum cup; however, these designs have the disadvantage of having vacuum maintained between the vacuum cup and the workpiece, even after the supply of vacuum is disengaged. Thus, such designs typically provide a supply of pressurized air to the vacuum cup after the vacuum is disengaged in order to release the workpiece from the vacuum cup. These designs require that two sources of air pressure, i.e., vacuum and atmospheric air pressure, be provided along with separate air lines, thereby providing a more complex and costly design.

Other known vacuum cup assembly designs utilize a venturi to create or provide vacuum to the vacuum cup. When the supply of pressurized air is disengaged from such venturi designs, air at atmospheric pressure is typically directed into the vacuum cup through a separate control mechanism, such as a valve assembly, thereby allowing for the release of the workpiece from the vacuum cup. Such designs typically provide a separate passageway for the valve assembly and the flow of atmospheric air, thereby requiring a time lag from the time in which the pressurized air is disengaged from the venturi to the time in which the workpiece disengages from the vacuum cup. This time lag creates an inefficiency that is undesirable in an industrial environment.

It would be desirable to create a vacuum cup assembly that allowed for the quick and immediate release of a workpiece from a vacuum cup upon disengaging vacuum from the vacuum cup.

### SUMMARY OF THE INVENTION

The present invention provides an apparatus for providing vacuum to a material handling device. The apparatus of the present invention provides a housing having an aperture, wherein the aperture has an inlet end for receiving a supply of pressurized air. The housing of the apparatus is connectable to the material handling device, and a vacuum passageway in the housing extends from the aperture in the housing to the material handling device. A venting passageway extends from the aperture of the housing to atmospheric air pressure. A valve is slidably disposed within the aperture in the housing, and the valve has a venturi nozzle formed therein. The valve is moveable between a vacuum position, wherein the venturi nozzle is in communication with the vacuum passageway for creating vacuum in the material handling device when the pressurized air flows through the venturi nozzle, and a release position, wherein the venting passageway is in communication with the vacuum passageway for providing atmospheric air pressure to the material handling device.

The valve of the present invention is biased toward the release position by a compression spring, and the valve engages a flexible seal when the valve is in the vacuum position for sealing the vacuum passageway from the venting passageway.

The aperture in the housing may have an outlet end for receiving a silencer for exhausting pressurized air from the housing. In the alternative, the outlet end may receive a manual release button that may be moved to abut the valve in the vacuum position, thereby forcing pressurized air through the vacuum passageway into said material handling device to release the workpiece.

The housing of the apparatus may also have a spherical ball mount engageable with a manipulator, wherein the aperture and the inlet in the housing extend through the spherical ball mount for receiving the supply of pressurized air.

Other objects, features, and advantages of the present invention will become apparent by reference to the following specification and to the drawings.

### BRIEF DESCRIPTION OF THE DRAWINGS

The description herein makes reference to the accompanying drawings wherein like referenced numerals refer to like parts throughout several views and wherein:

FIG. 1 is an isometric view of the single line venturi apparatus of the present invention showing the inlet side of the single line venturi apparatus;

FIG. 2 is an isometric view of the single line venturi apparatus of the present invention showing the outlet side of the single line venturi apparatus;

FIG. 3 is a sectional view of the single line venturi apparatus of the present invention showing the single line venturi apparatus in the vacuum position;

FIG. 4 is a sectional view of the single line venturi apparatus of the present invention showing the single line venturi apparatus in the release position;

FIG. 5 is an assembly view of the single line venturi apparatus of the present invention;

FIG. 6 is a perspective view of another embodiment of the single line venturi apparatus of the present invention;

FIG. 7 is an assembly view of the embodiment in FIG. 6 of the single line venturi apparatus of the present invention;

FIG. 8 is a sectional view of the embodiment in FIG. 6 of the single line venturi apparatus of the present invention shown in the vacuum position;

FIG. 9 is a sectional view of the embodiment in FIG. 6 of the single line venturi apparatus of the present invention shown in the release position;

FIG. 10 is a sectional view of the embodiment in FIG. 6 of the single line venturi apparatus of the present invention shown in the manual release position;

FIG. 11 is a sectional view of an additional embodiment of the single line venturi apparatus of the present invention showing the inlet extending through a spherical ball mount; and

FIG. 12 is a perspective view of the embodiment shown in FIG. 11 of the single line venturi apparatus of the present invention showing the spherical ball mount connected to a manipulator.

### DETAILED DESCRIPTION OF THE EMBODIMENTS

Referring to the drawings, the present invention will now be described in detail with reference to the disclosed embodiment.

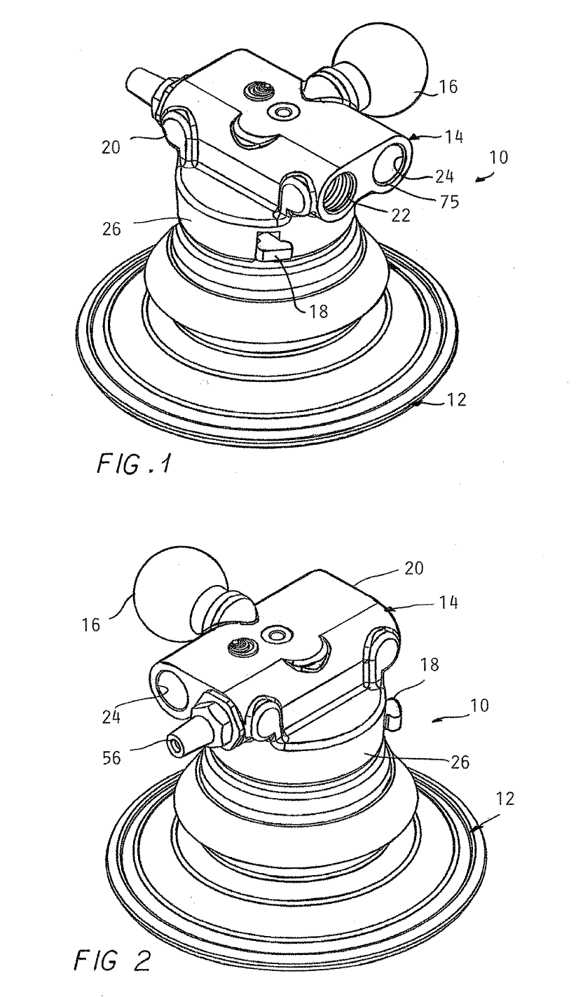

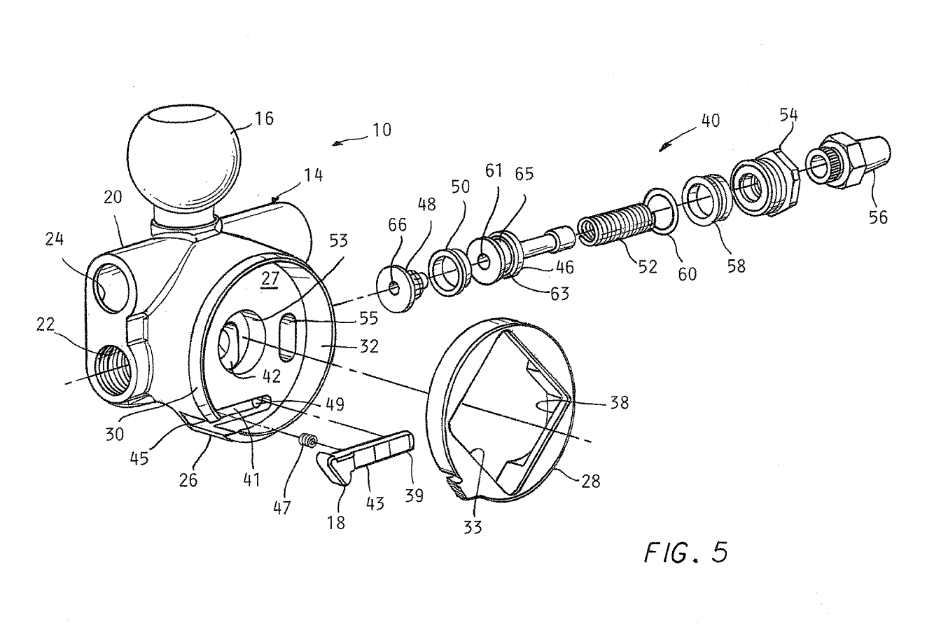

The present invention provides a single line venturi apparatus 10 for providing vacuum to a material handling device 12, such as a vacuum cup. As seen in FIGS. 1-12, the single line venturi apparatus 10 provides a housing 14 and a substantially spherical ball mount 16 extending outward from the housing 14. The spherical ball mount 16 is adaptable to be engaged to a mounting bracket 15 of a manipulator 17, such as a robotic arm. The manipulator 17 provides movement of the apparatus 10 and/or a workpiece 19, which may be releasably secured to the material handling device 12 of the apparatus 10. The housing 14 of the apparatus 10 houses a valve 40 that is moveable between a vacuum position, wherein the apparatus 10 generates vacuum to the material handling device 12 for engaging and securing the workpiece 19, and a release position, wherein the apparatus 10 provides a quick and effective disengagement of the workpiece 19 from the material handling device 12 upon the disengagement of vacuum to the material handling device 12. Thus, the single line venturi apparatus 10 of the present invention provides significant structural and functional advantages over the prior art.

The housing 14 of the vacuum apparatus 10 provides a substantially rounded rectangular body 20 having a pair of substantially parallel apertures 22, 24 extending through the body 20, as seen in FIGS. 1-5. As previously described, the spherical ball mount 16 may extend from a side of the body 20 and may be formed integrally with the body 20 or may be connected to the body 20 through the use of a threaded aperture or by welding the spherical ball mount 16 to the body 20. As will be described later in the specification, the spherical ball mount 16 may also extend from an end of the body 20. Although the spherical ball mount 16 is described as having a spherical ball configuration, it is intended that the scope of the subject patent application cover various geometric configuration of the mount 16 while still maintaining the functional characteristics of the mount 16. The housing 14 of the apparatus 10 may also have a substantially cylindrical mount 26 for receiving and securing the material handling device 12. The cylindrical mount 26 of the housing 14 has a floor 27 and a substantially cylindrical wall 32 that is integrally formed with the body 20 of the housing 14 and extends downward and off-center from a bottom of the body 20 of the housing 14. The entire housing 14 of the vacuum apparatus 10 may be fabricated from a lightweight, high-strength material, such as aluminum or plastic.

To releasably connect the material handling device 12 to the vacuum apparatus 10, the cylindrical mount 26 of the body 20 of the vacuum apparatus 10 provides an insert 28 seated on the floor 27 of the cylindrical mount 26 and captured within the cylindrical mount 26 by a circumferential lip or shoulder 30 of the cylindrical mount 26. The shoulder 30 extends radially inward, substantially perpendicular and integral with the wall 32 of the cylindrical mount 26. The insert 28 of the cylindrical mount 26 forms a substantially square opening 33 in the entrance of the cylindrical mount 26 for receiving a substantially square engaging member 34 on the material handling device 12. Each of the walls 36 of the insert 28 defining the substantially square opening 33 into the cylindrical mount 26 have an arcuate recess 38 formed below the portion of the walls 36 defining the substantially square opening 33. The arcuate recesses 38 in the insert 28 allow the substantially square engaging member 34 of the material handling device 12 to be rotated within the cylindrical mount 26 once the engaging member 34 of the material handling device 12 has been inserted axially past the square opening 33 of the insert 28. Once the engaging member 34 of the material handling device 12 is rotated within the arcuate recesses 38 of the insert 28, the engaging member 34 and the material handling device 12 are prevented from moving axially relative to the cylindrical mount 26, as the walls 36 of the insert 28 defining the substantially square opening 33 engage and prevent the engaging member 34 from moving out of the cylindrical mount 26. The insert 28 of the cylindrical mount 26 may be fabricated from a high-strength material that resists wear, such as brass.

To lock the engaging member 34 in the cylindrical mount 26, a locking lever 18 is fabricated from a thin strip of metal having a substantially flat portion 39 seated within a recess 41 in the floor 27 of the cylindrical mount 26. The locking lever 18 may be either tack welded, riveted, or adhered to the recess 41 within the cylindrical mount 26 at the end of the locking lever 18. The locking lever 18 has a bent portion 43, which rises from the substantially flat portion 39 of the locking member 18, and the substantially bent portion 43 of the locking member 18 extends through an aperture 45 provided in the insert 28 and the wall 32 of the cylindrical mount 26. A small compression spring 47 may be disposed between the locking member 18 and an aperture 49 in the recess 41 in the floor 27 of the cylindrical mount 26 to bias the locking member 18 upward or toward the material handling device 12. Upon inserting the engaging member 34 of the material handling device 12 into the cylindrical mount 26 and rotating the engaging member 34 in the insert 28, a corner of the substantially square engaging member 34 engages and forces the bent portion 43 of the locking lever 18 down, as the engaging member 34 and the material handling device 12 are rotated within the cylindrical mount 26. Once the corner of the engaging member 34 extends past the bent portion 43 of the locking lever 18, the spring 47 biases the bent portion 43 of the locking lever 18 upward past the engaging member 34, thereby preventing the engaging member 34 of the material handling device 12 from rotating toward an unlocked position. To remove the engaging member 34 from the cylindrical mount 26, the portion of the locking member 18 extending outward from the cylindrical mount 26 must be depressed, thereby allowing the corner of the engaging member 34 to rotate past the bent portion 43 of the locking lever 18 and allowing the substantially square portion of the engaging member 34 to align with the substantially square opening 33 in the insert 28, thereby establishing an unlocked position. Once the engaging member 34 is in the unlocked position, the engaging member 34 of the material handling device 12 may be removed from the cylindrical mount 26 of the apparatus 10.

In order to provide vacuum to the material handling device 12, the valve 40 is housed within the aperture 22 of the body 20 of the housing 14 of the vacuum apparatus 10. The other aperture 24 in the body 20 of the housing 14 is provided for reducing the weight of the apparatus 10. The aperture 24 may be capped at both ends with plugs (not shown), or the aperture 24 may be left open. In the alternative, the aperture 24 and/or the portion of the body 20 defining the aperture 24 may be eliminated. The aperture 22 of the body 20 that houses the valve 40 is in communication with the material handling device 12 through a vacuum passageway 42 which extends from the aperture 22 in the housing 14 into the floor 27 of the cylindrical mount 26. The vacuum passageway 42 extends substantially perpendicular to a longitudinal axis 51 of the aperture 22 and opens into a centrally located aperture 53 provided in the floor 27 of the cylindrical mount 26. A venting passageway 55 may also be provided in the housing 14 for allowing atmospheric air pressure into the aperture 22. The venting passageway 55 extends substantially perpendicular to the longitudinal axis 51 of the aperture 22 and extends from the aperture 22 of the housing 14 into the floor 27 of the cylindrical mount 26 in an area that is offset from the center of the cylindrical mount 26. The vacuum passageway 42 and the venting passageway 44 are positioned within the cylindrical mount 26 such that when the engaging member 34 of the material handling device 12 is secured within the cylindrical mount 26 in the locked position, a material handling passageway 57 within the material handling device 12 is held in communication with the vacuum passageway 42 so as to provide vacuum to the material handling device 12 as the material handling passageway 57 is in direct communication with the workpiece 19. A seal 59 is provided in the engaging member 34 of the material handling device 12 to seal the vacuum passageway 42 and the aperture 53 to the material handling passageway 57. In addition, the engaging member 34 of the material handling device 12 is positioned such that it does not entirely cover the opening of the venting passageway 44 in the floor 27 of the cylindrical mount 26 so as to allow for atmospheric air pressure to flow through the venting passageway 44 into the aperture 22.

To engage and disengage vacuum to the material handling device 12, the valve 40 is housed within the aperture 22 of the body 20 and is movable between the vacuum position and the released position. The valve 40 provides a diffuser 46 and a nozzle 48 slidably disposed within the aperture 22 of the body 20. The diffuser 46 has a substantially cylindrical spool valve configuration having an aperture or bore 61 extending therethrough along the longitudinal axis 51 of the diffuser 46. The head or larger end portion of the diffuser 46 has a circumferential recess 63 with a cross-bore 65 extending substantially perpendicular to the longitudinal axis 51 of the diffuser 46. The nozzle 48 is also substantially cylindrical having a narrowed end portion, which matingly engages the aperture 61 in the end of the diffuser 46. The nozzle 48 and diffuser 46 may be connected by a press fit, or the nozzle 48 and the diffuser 46 may be connected by some other conventional manner. The nozzle 48 has an aperture or bore 66 that extends therethrough along the longitudinal axis 51 of the nozzle 48. The aperture or bore 66 in the nozzle 48 has a narrowing portion 67 therein, which accelerates the speed at which pressurized air flows through the nozzle 48. The nozzle 48 has a cross-bore 69 extending substantially perpendicular to the longitudinal axis 51 of the aperture 66, and the cross-bore 69 is in communication with the cross-bore 65 in the diffuser 46. When a supply of pressurized air is provided in the inlet of the aperture 22 of the body 20, the pressurized air flows through the narrowing portion 67 in the aperture 66 of the nozzle 48, thereby drawing air inward from the substantially perpendicular cross-bores 65, 69 in the diffuser 46 and the nozzle 48, thereby creating vacuum in the material handling device 12. This creation of vacuum by passing pressurized air through the narrowing portion 67 is commonly referred to as a venturi.

In order to provide a seal between the nozzle 48 and the portion of the housing 14 defining the aperture 22, the nozzle 48 has a stepped outer diameter for receiving a U-cup seal 50 between the largest outer diameter of the nozzle 48 and the end of the diffuser 46. The U-cup seal 50 allows movement of the nozzle 48 while maintaining a seal between the outer surface of the nozzle 48 and the portion of the housing 14 defining the aperture 22.

To bias the diffuser 46 and the nozzle 48 of the valve 40 toward the release position, a biasing member, such as compression spring 52, is seated over the diffuser 46 within the aperture 22 of the body 20. An exhaust plug 54 is threaded into an outlet end 77 of the aperture 22, and one end of the spring 52 is seated against the exhaust plug 54. A silencer or diffuser 56 having a substantially conical configuration may then be threaded into the exhaust plug 54 to reduce the noise associated with exhausting the supply of pressurized air through the outlet end 77 of the aperture 22.

In order to limit the travel of the diffuser 46 and the nozzle 48 of the valve 40 in the vacuum mode and define the vacuum position, a spacer 58 is fitted within the aperture 22 of the body 20. A flexible O-ring seal 60 is seated against the spacer 58 within the aperture 22 for engagement with the diffuser 46 when the diffuser 46 is in the vacuum position. The spacer 58 and the O-ring 60 are positioned such that when the diffuser 46 engages the O-ring 60, the cross-bores 65, 69 provided in the diffuser 46 and the nozzle 48 are in sealed communication with the vacuum passageway 42 leading from the aperture 22 to the material handling device 12. In addition, the cross-bores 65, 69 and the vacuum passageway 42 are sealed from the venting passageway 55.

In operation, the engaging member 34 of the material handling device 12 is seated within the cylindrical mount 26 of the housing 14 of the apparatus 10 in a locked position, and a supply of pressurized air 80 is connected to an inlet end 75 of the aperture 22 in the body 20 of the apparatus 10. In the release position, the supply of pressurized air 80 is maintained at a low pressure so as not to overcome the spring force provided by the compression spring 52 against the diffuser 46. Thus, the nozzle 48 is biased against a shoulder 73 in the aperture 22 of the body 20 to establish the released position, as shown in FIG. 4, and contain the valve 40 within the aperture 22 of the body 20. In the release position, the workpiece 19 is released from the material handling device 12, as there is no vacuum to secure the workpiece 19 to the material handling device 12.

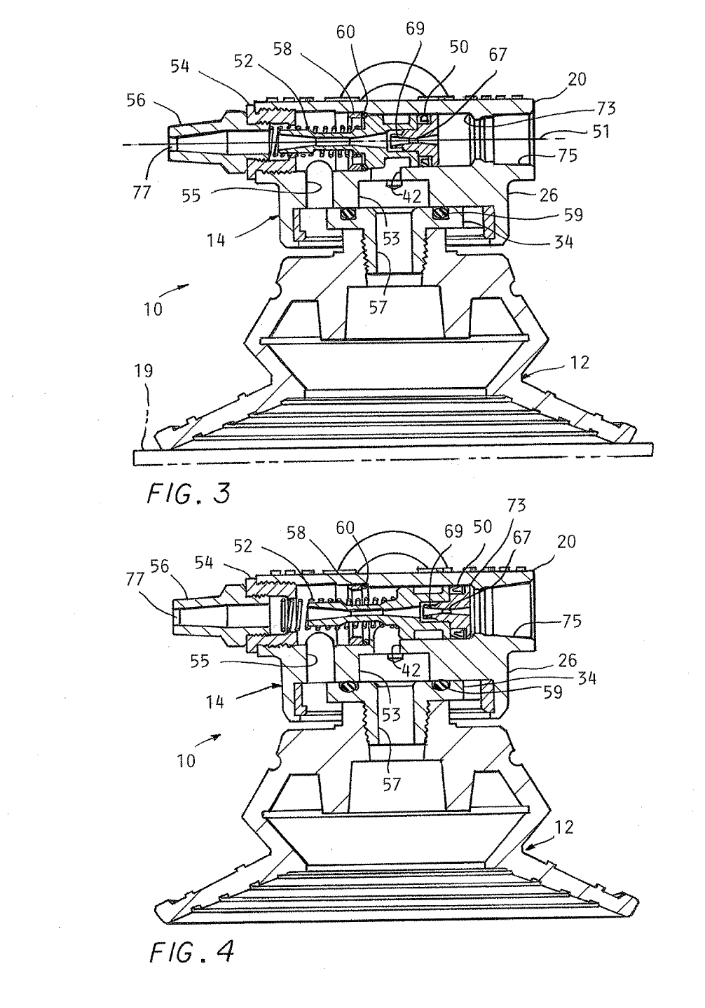

In the vacuum mode, the supply of pressurized air 80 is increased through the inlet 75 of the aperture 22 of the body 20 such that the force of the pressurized air forces the diffuser 46 and the nozzle 48 of the valve 40 to compress the spring 52, thereby allowing the diffuser 46 and the nozzle 48 of the valve 40 to move toward the outlet end 77 of the aperture 22 of the body 20 until the diffuser 46 engages the O-ring 60, as seen in FIG. 3. Once the diffuser 46 is seated against the O-ring 60, the pressurized air flowing through the narrowing portion 67 of the nozzle 48 draws air in through the cross-bores 65, 69 and the vacuum passageway 42, thereby creating vacuum in the material handling device 12. The vacuum in the material handling device 12 allows the material handling device 12 to secure the workpiece 19 for movement thereof. When the workpiece 19 is to be released from the material handling device 12, the supply of pressurized air 80 is reduced, and the compression spring 52 immediately returns the diffuser 46 and the nozzle 48 of the valve 40 toward the released position, as seen in FIG. 4. Atmospheric air pressure immediately flows from the aperture 22 into the material handling device 12, thereby allowing the workpiece 19 to be released in a quick and efficient manner.

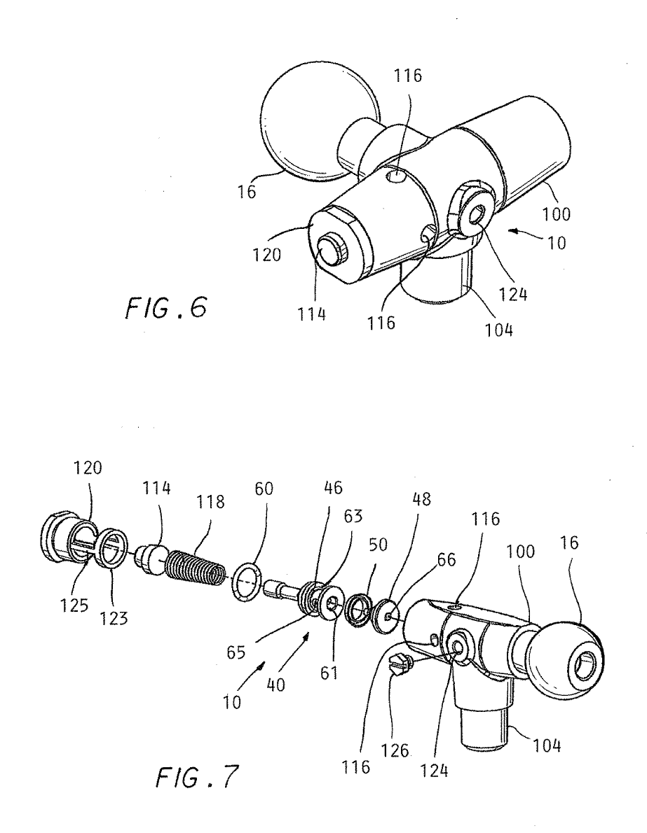

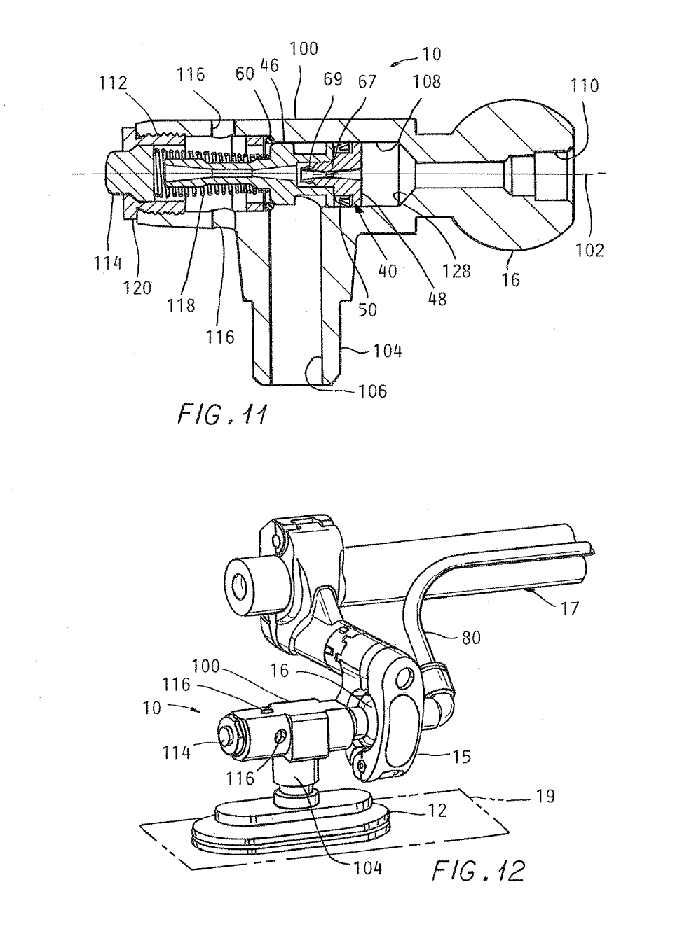

In an additional embodiment of the single line venturi apparatus 10 of the present invention, a housing 100 of the single line venturi apparatus 10 has been reduced in size, as compared to the housing 14 in the first embodiment, as seen in FIGS. 6-12. The housing 100 has a substantially cylindrical configuration, which tapers slightly from its larger mid-section to its smaller end portions. However, the housing 100 may not have the taper, as seen in FIGS. 11-12, or the housing 100 may have substantially flat surfaces, as seen in FIG. 12. The housing 100 may also have a similar, substantially spherical ball mount 16 extending outward from the housing 100, as described in the previous embodiment. The spherical ball mount 16 may extend at an angle substantially perpendicular to a longitudinal axis 102 of the housing 100, as seen in FIGS. 6-9, or the spherical ball mount 16 may extend substantially coaxially to the longitudinal axis 102 of the housing 100, as seen in FIGS. 11-12. Again, the spherical ball mount 16 is adaptable to engage to the mounting bracket 15 of the manipulator 17, such as a robotic arm, and it is also anticipated that the spherical ball mount 16 may take on various geometric configurations. As previously described, the manipulator 17 provides movement of the apparatus 10 and/or the workpiece 19, which may be releasably secured to the material handling device 12. In this embodiment, the housing 100 of the apparatus 10 houses a similar valve 40 as the previously-described embodiment, wherein the valve 40 is moveable between the vacuum position, wherein the apparatus 10 generates vacuum to the material handling device 12 for engaging the workpiece 19, and the release position, wherein the apparatus 10 provides a quick and effective disengagement of the workpiece 19 from the material handling device 12 upon the disengagement of vacuum to the material handling device 12.

To connect the material handling device 12 to the apparatus 10, the housing 100 of the apparatus 10 provides a substantially cylindrical mounting portion 104 which extends integrally from the housing 100 at a substantially right angle from the longitudinal axis 102 of the housing 100. The material handling device 12 may be connected to the mounting portion 104 of the housing 100 through any conventional connecting means, such as by threads, fasteners, welds, adhesives, etc. The mounting portion 104 of the housing 100 has a vacuum passageway 106 which extends from the longitudinal axis 102 of the housing 100 to the interior of the material handling device 12. The entire housing 100 of the vacuum apparatus 10 may be fabricated from a light-weight, high-strength material, such as aluminum or plastic.

In order to provide vacuum to the material handling device 12, the valve 40 is housed within an aperture 108 that extends through the housing 100 along the longitudinal axis 102 of the housing 100. The aperture 108 of the housing 100 provides an inlet 110 at one end of the aperture 108 for receiving the supply of pressurized air 80. The housing 100 also provides an outlet end 112 at the opposite end of the aperture 108, wherein a manual override button or release member 114 may be provided. The manual override button 114 will be described in detail later in the specification. The aperture 108 of the housing 100 communicates with the vacuum passageway 106 of the mounting portion 104 and venting passageways 116 which extend through the housing 100 at angles substantially perpendicular to the longitudinal axis 102 of the housing 100. The venting passageways 106 lie between the outlet end 112 and the vacuum passageway 106 of the mounting portion 104. The venting passageways 116 provide four apertures or passageways spaced 90° circumferentially. The venting passageways 116 exhaust pressurized air from the aperture 108 of the housing 100 when the valve 40 is in the vacuum position and supply air at atmospheric pressure to the material handling device 12 when the valve 40 is in the release position.

To provide vacuum to the material handling device 14, the valve 40 is similar to the valve 40 in the previous embodiment in that the valve 40 provides a diffuser 46 and a nozzle 48 slidably disposed within the aperture 108 of the housing 100. The diffuser 46 has a substantially cylindrical spool valve configuration having an aperture or bore 61 extending therethrough along the longitudinal axis 102 of the diffuser 46. The head or larger end portion of the diffuser 46 has a circumferential recess 63 with a cross-bore 65 extending substantially perpendicular to the longitudinal axis 102 of the diffuser 46. The nozzle 48 is also substantially cylindrical having a narrowed end portion which matingly engages the aperture 61 in the end of the diffuser 46. The nozzle 48 and the diffuser 46 may be connected by a press fit or by any other conventional fastening means. The nozzle 48 has an aperture or bore 66 that extends therethrough along the longitudinal axis 102 of the nozzle 48. The aperture or bore 66 in the nozzle 48 has a narrowing portion 67 therein, which accelerates the speed at which pressurized air flows through the nozzle 48. The nozzle 48 has a cross-bore 69 extending substantially perpendicular to the longitudinal axis 102 of the aperture or bore 66, and the cross-bore 69 is in communication with the cross-bore 65 of the diffuser 46. When the supply of pressurized air is provided to the inlet 110 of the aperture 108 in the housing 100, the pressurized air flows through the narrowing portion 67 in the aperture or bore 66 of the nozzle 48, thereby drawing air inward from the perpendicular cross-bores 65, 69 in the diffuser 66 and the nozzle 48 of the valve 40, thereby creating vacuum in the material handling device 12. Once again, this creation of vacuum by passing pressurized air through the narrowing portion 67 is commonly referred to as a venturi.

In order to provide a seal between the nozzle 48 and the portion of the housing 100 defining the aperture 108, the nozzle 48 has a stepped outer diameter for receiving the U-cup seal 50 between the largest outer diameter of the nozzle 48 and the end of the diffuser 46. The U-cup seal 50 allows movement of the nozzle 48 while maintaining a seal between the outer surface of the nozzle 48 and the portion of the housing 14 defining the aperture 22.

To bias the diffuser 46 and the nozzle 48 of the valve 40 toward the release position, a biasing member, such as a compression spring 118, is fitted over the diffuser 46 within the aperture 108 of the housing 100. An exhaust plug 120 is threaded into the outlet end 112 of the aperture 108. The exhaust plug 120 has an aperture extending therethrough for receiving the manual release button 114. The button 114 has a substantially cylindrical configuration having a stepped outer diameter such that the smaller diameter extends through the aperture in the exhaust plug 120 while the larger diameter of the button 114 is larger than the aperture in the exhaust plug 120, thereby preventing the button 114 from passing through the aperture of the exhaust plug 120. Thus, the button 114 is captured and retained by the exhaust plug 120 while allowing the button 114 to move between an extended position and a depressed position. The compression spring 118 engages and biases the button 114 toward the extended position. When the button 114 is in the extended position, the button 114 does not affect the operation of the apparatus 10, as the valve 40 is free to move between the vacuum position and the release position. If the user wishes to manually release the workpiece 19 from the material handling device 12 while the valve 40 is in the vacuum position, the user may depress the button 114 thereby causing the larger end of the button 114 to abut the end of the valve 40. When this occurs, the pressurized air is prevented from exhausting through the end of the valve 40. This creates a backflow of air through the valve 40 such that the pressurized air can no longer flow through the diffuser 46 to create vacuum. Instead, pressurized air is forced through the vacuum passageway 106 into the material handling device 12, thereby releasing the workpiece 19. This immediately allows for the release of the workpiece 19 from the material handling device 12, even though the valve 40 remains in the vacuum position. Once the button 114 is released, the compression spring 118 biases the button 114 back to the extended position, thereby allowing pressurized air to flow through the valve 40 to create vacuum in the material handling device 12.

In order to limit the travel of the diffuser 46 and the nozzle 48 of the valve 40 in the vacuum mode and define the vacuum position, a spacer 123 is provided within the aperture 108 of the housing 100. The spacer 123 extends integrally from the exhaust plug 120 by a pair of support members 125. The flexible 0-ring seal 60 is seated against the spacer 123 within the aperture 108 of the housing 100 for engaging with the diffuser 46 when the diffuser 46 is in the vacuum position. The spacer 123 and the seal 60 are positioned such that when the diffuser 46 engages the seal 60, the cross-bores 65, 69 provided in the diffuser 46 and the nozzle 48 are in communication with the vacuum passageway 106 leading from the aperture 108 in the housing 100 to the material handling device 12.

In order to monitor the air pressure within the housing 100, the apparatus 10 provides an aperture 124 in the midsection of the housing 100. The aperture 124 may receive a conventional pressure sensor (not shown), which may monitor the pressure or vacuum within the housing 100. The pressure sensor may provide a signal to a programmable controller (not shown) for controlling the apparatus 10. If a pressure sensor is not fitted within the aperture 124 of the housing 100, a sensor plug 126 having a seal may be threaded into the aperture 124 for sealing the aperture 124.

As previously noted, the spherical ball mount 16 of the housing 100 may extend integrally from the housing 100 at an angle substantially perpendicular to the longitudinal axis 102 of the housing 100 or may extend coaxially with the longitudinal axis 102 of the housing 100 from one end of the housing 100, as seen in FIGS. 11-12. When the spherical ball mount 16 extends coaxially with the longitudinal axis 102 of the housing 100, the aperture 108 may extend along the longitudinal axis 102 of the housing 100 through the spherical ball mount 16. This allows the supply of pressurized air 80 to be connected through the end of the spherical ball mount 16, thereby providing greater flexibility for the mounting of the apparatus 10 to the manipulator 17. In doing so, the apparatus 10 may be mounted on either side of the mounting bracket 15.

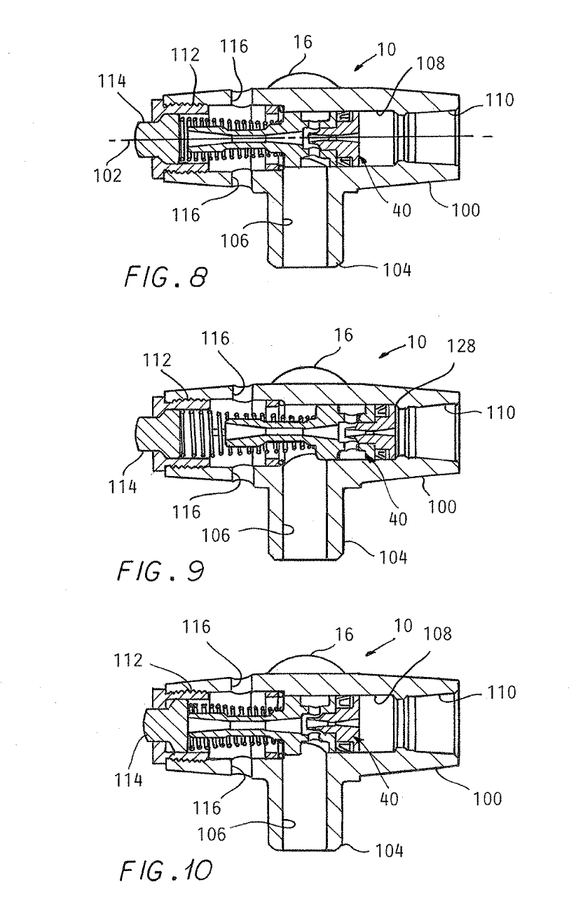

In operation, the apparatus disclosed in the additional embodiment will operate in a similar manner as described in the previous embodiment. For instance, in the release position, the supply of pressurized air 80 provided at the inlet 110 is maintained at a low pressure so as not to overcome the spring force provided by the compression spring 118 against the diffuser 46. Thus, the nozzle 48 is biased against a shoulder or taper 128 in the aperture 108 to establish the release position, as shown in FIGS. 9-10, and contain the valve 40 within the aperture 108 of the housing 100. In the release position, the workpiece 19 is released from the material handling device 12, as there is no vacuum to secure the workpiece 19 to the material handling device 12.

In the vacuum mode, the supply of pressurized air 80 is increased through the inlet 110 of the aperture 108 of the housing 100 such that the force of the pressurized air forces the diffuser 46 and the nozzle 48 to compress the compression spring 118, thereby allowing the diffuser 46 and the nozzle 48 of the valve 40 to move toward the outlet 112 of the aperture 108 until the diffuser 46 engages the O-ring seal 60, as seen in FIG. 8. Once the diffuser 46 is seated against the O-ring seal 60, the pressurized air flowing through the narrowing portion 67 of the nozzle 48 draws air in through the cross-bores 65, 69 and the vacuum passageway 106, thereby creating vacuum in the material handling device 12. The vacuum in the material handling device 12 allows the material handling device 12 to releasably secure the workpiece 19 for movement thereof. When the workpiece 19 is to be released from the material handling device 12, the supply of pressurized air 80 is reduced, and the compression spring 118 immediately returns the diffuser 46 and the nozzle 48 of the valve 40 toward the release position, as seen in FIG. 9. Air at atmospheric pressure immediately flows from the venting passageways 116, through aperture 108, and into the material handling device 12, thereby allowing the workpiece 19 to be released in a quick and efficient manner.

However, when the apparatus 10 is in the vacuum mode, the manual release button 114 may be depressed in order to force pressurized air into the material handling device 12, thereby releasing the workpiece 19. When depressing the button 114, the button 114 abuts the valve 40 and prohibits pressurized air from exhausting through the valve 40. This forces the pressurized air back through the vacuum passageways 106 and into the material handling device 12. The pressurized air allows the workpiece 19 to be released from the material handling device 12 without having to reduce the supply of pressurized air to the inlet 110 of the housing 100. By releasing the button 114, the button 114 is biased back to the extended position by the compression spring 118, and pressurized air is allowed to flow through the valve 40, thereby creating vacuum in the material handling device.

While the invention has been described in connection with what is presently considered to be the most practical and preferred embodiment, it is to be understood that the invention is not to be limited to the disclosed embodiments, but to the contrary, it is intended to cover various modifications or equivalent arrangements included within the spirit and scope of the appended claims. The scope is to be accorded the broadest interpretation so as to encompass all such modifications and equivalent structures as is permitted under the law.

What is claimed is:

1. An apparatus for providing vacuum to a material handling device, comprising:
a housing having an aperture with an inlet end for receiving a supply of pressurized air, and said housing connectable to said material handling device;
a vacuum passageway extending from said aperture in said housing to said material handling device;
a venting passageway extending from said aperture in said housing to atmospheric air pressure;
a valve slidably disposed within said aperture of said housing, and said valve having a venturi nozzle formed therein; and
said valve moveable between a vacuum position, wherein said venturi nozzle is in communication with said vacuum passageway for creating vacuum in said material handling device when pressurized air flows through said venturi nozzle, and a release position, wherein said venting passageway is in communication with said vacuum passageway for providing atmospheric air pressure to said material handling device.

2. The apparatus stated in claim 1, further comprising:
said valve biased toward said released position.

3. The apparatus stated in claim 1, further comprising:
said valve engaging a flexible seal when said valve is in said vacuum position for sealing off said vacuum passageway from said venting passageway.

4. The apparatus stated in claim 1, further comprising:
said housing having an outlet end; and
a silencer connected to said outlet end of said housing for exhausting pressurized air from said housing.

5. The apparatus stated in claim 1, further comprising:
said housing having an outlet end; and
a release member disposed within said outlet end of said housing, and said release member moveable to abut said valve in said vacuum position, thereby forcing pressurized air through said vacuum passageway into said material handling device.

6. The apparatus stated in claim 1, further comprising:
said housing having a mount engageable with a manipulator, wherein said aperture and said inlet end extend through said mount.

7. An apparatus for providing vacuum to a material handling device, comprising:
a housing having an aperture extending therethrough, and said aperture having an inlet end for receiving a supply of pressurized air and an outlet end;
said housing connectable to a material handling device;
a vacuum passageway in said housing extending from said aperture in said housing to said material handling device;
a venting passageway in said housing extending from said aperture in said housing to atmospheric air pressure;
a valve slidably disposed within said aperture of said housing, and said valve having a bore extending therethrough and a cross-bore extending through said bore with a venturi nozzle formed in said bore for generating vacuum through said cross-bore when said pressurized air passes through said venturi nozzle; and
said valve moveable between a vacuum position, wherein said valve engages a flexible seal disposed in said aperture for sealing said vacuum passageway from said venting passageway and creating vacuum in said material handling device, and a release position, wherein said venting passageway is in communication with said vacuum passageway for providing atmospheric air pressure to said material handling device.

8. The apparatus stated in claim 7, further comprising:
a spring disposed within said aperture of said housing, and said spring engaging said valve for biasing said valve toward said release position.

9. The apparatus stated in claim 7, further comprising:
said flexible seal seated against a spacer disposed within said aperture of said housing; and
a landing formed on said valve for sealingly engaging said flexible seal in said vacuum position.

10. The apparatus stated in claim 7, further comprising:
a silencer connected to said outlet end of said housing for exhausting pressurized air from said housing.

11. The apparatus stated in claim 8, further comprising:
a release button disposed within said outlet end of said housing, and said release button moveable between an outward position, wherein said manual release button is biased toward said outward position by said spring, and an inward position, wherein said release button may abut said valve, thereby forcing pressurized air into said vacuum passageway and into said material handling device.

12. The apparatus stated in claim 7, further comprising:
a ball mount extending coaxially along a longitudinal axis of said housing and engageable with a manipulator, wherein said aperture and said inlet end of said housing extend through said ball mount.

13. An apparatus for providing vacuum to a material handling device, comprising:
an integral housing having an aperture extending therethrough along a longitudinal axis of said housing, and said aperture having an inlet end for receiving a supply of pressurized air and an outlet end;
said housing connectable to a material handling device;
a vacuum passageway in said housing extending from said aperture in said housing to said material handling device;
a venting passageway in said housing extending from said aperture in said housing to an outside surface of said housing, thereby providing atmospheric air pressure to said venting passageway;
a valve slidably disposed within said aperture in said housing, and said valve having a bore extending therethrough and a cross-bore extending substantially perpendicular through said bore with a venturi nozzle formed in said bore for generating vacuum through said cross-bore when said pressurized air passes through said venturi nozzle; and
said valve moveable along said longitudinal axis of said housing between a vacuum position, wherein said valve engages a flexible seal disposed in said aperture of said housing for sealing said vacuum passageway from said venting passageway for creating vacuum in said material handling device, and a release position, wherein said venting passageway is in communication with said vacuum passageway for providing atmospheric air pressure to said material handling device.

14. The apparatus stated in claim 13, further comprising:
a compression spring disposed within said aperture of said housing, and said compression spring engaging said valve for biasing said valve in said release position.

15. The apparatus stated in claim 13, further comprising:
said first flexible seal seated on a spacer mounted within said aperture of said housing on one side of said vacuum passageway;
a landing formed on said valve for sealingly engaging said first flexible seal in said vacuum position; and
a second flexible seal seated within a recess of said valve on an opposite side of said vacuum passageway from said first flexible seal.

16. The apparatus stated in claim 13, further comprising:
a substantially conical-shaped silencer connected to said outlet end of said housing for exhausting pressurized air from said housing.

17. The apparatus stated in claim 13, further comprising:
a manual release button disposed within said outlet end of said housing, and said manual release button moveable between an outward position, wherein said manual release button is biased toward said outward position by said compression spring, and an inward position, wherein said manual release button may abut said valve, thereby forcing pressurized air into said vacuum passageway and into said material handling device.

18. The apparatus stated in claim 13, further comprising:
a substantially spherical ball mount extending coaxially along a longitudinal axis of said housing and engageable with a manipulator, wherein said aperture and said inlet end in said housing extend through said spherical ball mount.

19. The apparatus stated in claim 17, wherein said manual release button further comprises:
a substantially cylindrical shaped exhaust plug disposed within said outlet end of said housing and having an aperture extending therethrough; and
a substantially cylindrical-shaped button having a stepped outer diameter, wherein said button extends at least partially through said aperture of said exhaust plug such that said button is captured within said exhaust plug, thereby allowing said button to move between said outward position and said inward position.
